(19) United States
(12) Patent Application Publication
(10) Pub. No.: US 2024/0056924 A1
(43) Pub. Date: Feb. 15, 2024

(54) METHOD AND APPARAUTS FOR HANDLING TRANSMISSION-RECEPTION POINTS IN COMMUNICATION SYSTEM

(71) Applicant: Samsung Electronics Co., Ltd., Suwon-si (KR)

(72) Inventors: Arvind RAMAMURTHY, Bangalore (IN); Neha SHARMA, Bangalore (IN)

(21) Appl. No.: 18/448,478

(22) Filed: Aug. 11, 2023

Related U.S. Application Data
(63) Continuation of application No. PCT/KR2023/011869, filed on Aug. 10, 2023.

(30) Foreign Application Priority Data
Aug. 12, 2022 (IN) 202241045987

(51) Int. Cl. H04W 36/08; H04B 7/024

(52) U.S. Cl. CPC H04W 36/08; H04B 7/024

(57) ABSTRACT

A method for handling transmission-reception points (TRPs) by a user equipment (UE) in a communication system including multiple TRPs, comprising: receiving a plurality of TRP signals from a plurality of TRPs in the communication system; determining a set of TRPs from the plurality of TRPs based on a plurality of network parameters; clustering the set of TRPs into at least one cluster based on at least one characteristic related to the plurality of TRP signals; selecting a cluster for path switching from the at least one cluster; determining whether the selected cluster comprises a TRP better than a current TRP used by the UE; switching to the better TRP from the current TRP based on determining that the selected cluster comprises the TRP better than the current TRP; and transmitting a TRP switch message to at least one network apparatus.

### CROSS-REFERENCE TO RELATED APPLICATIONS

This application is a continuation of International Application No. PCT/KR2023/011869 designating the United States, filed on Aug. 10, 2023, in the Korean Intellectual Property Receiving Office and claiming priority to Indian Provisional Patent Application No. 202241045987 filed on Aug. 12, 2022, and to Indian Complete Patent Application No. 202241045987, filed on Jul. 21, 2023, in the Indian Patent Office, the disclosures of each of which are incorporated by reference herein in their entireties.

### BACKGROUND

### Field

The disclosure relates to a field of wireless communication and systems, and for example, to a method for designing measurement model for multi-Transmission/Reception Point (TRP) system.

### Description of Related Art

In general, several broadband wireless technologies have been developed for providing better applications and services to meet the growing requirements of broadband subscribers. A second generation wireless communication system has been developed to provide voice services while ensuring the mobility of users. A third generation wireless communication system supports not only a voice service but also data service. In recent years, a fourth wireless communication system has been developed to provide high-speed data service. However, currently, the fourth generation wireless communication system suffers from a lack of resources to meet growing demand for high-speed data services. The problem is addressed by the deployment of a fifth generation wireless communication system to meet the ever growing demand for high speed data services. Furthermore, the fifth generation wireless communication system provides ultra-reliability and supports low latency applications. Research is currently going on to define the requirements, systems and frameworks for the sixth generation of wireless communications that can address the limitations of 5G and support enhanced use cases.

A transmission and/or reception in a Terahertz band (THz) system or mmwave or mid band system are based on narrow beams that suppress interference from neighbouring base stations and extend range of the THz link. However, due to high path loss, heavy shadowing and rain attenuation, reliable transmission at higher frequencies is one of the key issues that need to be addressed to make the THz band wave systems a practical reality. The Multi TRP per cell or cell less or cell free architecture will break conventional design of the cellular system where each cell or area will have multiple TRPs. The multiple TRPs, together can form a large geographical area with continuous radio coverage. Each TRP may have one or more logical antennas enabling multiple beams to be formed. From a User Equipment (UE) perspective, UEs are connected to the network as a whole and not to a single cell. The coverage area or cell area or number of TRPs in particular area or cell and boundary of the multiple TRPs is configurable depending on the network topology, the UE distribution and traffic load situation.

Given the short coverage and narrow beam characteristics of the THz frequency based or mid band or mmwave based cellular system, in order to provide continuous coverage or service to the mobile user, a common system with cell-free architecture are used. Under such a system, a cell can include multiple TRP(s) on the same carrier/frequency. Further, a mobile user can be under the service of one or more of such TRP(s) in both downlink and/or uplink direction. From mobile user point of view, it's not necessary to distinguish all such serving TRP(s) or Access Point(s) with any specific identifier as they all can be just multiple sources of serving beams and any distinction between multiple TRP(s) can be achieved at beam level itself. The existing Measurement model is being defined for cellular based system. In the current measurement system, the UE has to always measure, report and then wait for the network to move the UE to the right cell/TRP. Although proven, the systems lack flexibility in terms of measurement reporting for new design that is the multi TRP there is a need to define a new Measurement model as existing mechanism is not scalable to handle such requirements.

Thus, it is desired to address the above mentioned disadvantages or other shortcomings or at least provide a useful alternative.

### SUMMARY

Embodiments of the disclosure provide a system and method to handle transmission-reception point (TRP) in a multi TRP telecommunication system.

According to various example embodiments, a system and method for handling transmission-reception point (TRP) in a multi TRP telecommunication system is provided. The disclosed method provides a scenario of area or cell including multi Transmission/Reception Point (TRP) of the radio network connected to the controller or Central-Random Access Network (C-RAN) or control unit. Further, the method provides a configuration in which where in a user device can be served by multiple beam/TRP IDs in Downlink (DL) and/or uplink in a multi-TRP system.

In an example embodiment, a method for handling transmission-reception points (TRPs) by a user equipment (UE) in a communication system including multiple TRPs is provided. The method includes receiving a plurality of TRP signals from a plurality of TRPs in the communication system. The method includes, determining a set of TRPs from the plurality of TRPs based on a plurality of network parameters. The network parameters/cell parameters include an uplink/downlink signal quality. The method includes clustering the set of TRPs into at least one cluster based on at least one characteristic related to the plurality of TRP signals. The at least one characteristic related to the plurality of TRP signals includes at least one of a location of the UE, a current time, and a current mobile condition of the UE, an uplink (UL) and downlink (DL) performance on each TRP, and an interference level associated with each TRP. The method includes selecting a cluster for path switching from the at least one cluster. The method includes determining whether the selected cluster comprises a TRP better than a current TRP used by the UE. The method includes switching to the better TRP from the current TRP based on determining that the selected cluster comprises the TRP better than the current TRP. The method includes transmitting a TRP switch message to at least one network apparatus.

In an example embodiment, clustering the set of TRPs into the at least one cluster includes determining an uplink (UL) synchronization for each of the set of the TRPs based on the at least one characteristic related to the plurality of TRP signals. Clustering the set of TRPs into the at least one cluster includes performing one of: adding at least one TRP from the set of TRPs that shares a same UL synchronization to the at least one cluster, sending a message informing about the at least one cluster to the at least one network apparatus, and eliminating at least one TRP from the set of TRPs that does not share the same UL synchronization.

The method includes determining a TRP from a plurality of TRP signals. The method includes determining a group of TRPs from the set of TRPs for different directions of the UE based on the at least one characteristic related to the plurality of TRP signals, wherein the group of TRPs for different directions of the UE provides that in whichever direction the UE moves a TRP is available to hop on without L3 measurement.

In an example embodiment, the method includes determining at least one candidate TRP from the set of TRPs by applying at least one machine learning model to a plurality of TRP signal characteristics, wherein the at least one candidate TRP is frequently used by the UE, and has a set of cell parameters. The set of cell parameters includes at least one of a higher threshold and a lower threshold Reference Signals Received Power (RSRP), a same Timing Advance (TA) values, a same TX power, a same UL path loss.

In an example embodiment, the method includes determining a TRP of the set of TRPs based on the group of TRPs for different directions of the UE, and the at least one candidate TRP.

In an example embodiment, switching to the better TRP from the current TRP includes performing a first layer (L1) measurement based on the better TRP. Switching to the better TRP from the current TRP includes determining whether an autonomous switch is configured at the UE. Switching to the better TRP from the current TRP includes switching from the current TRP to the optimal TRP based on the L1 measurement based on the autonomous switch being configured at the UE, and transmitting the TRP switch message to the at least one network apparatus.

In an example embodiment, the method includes reporting the L1 measurement to the at least one network apparatus to switch from the current TRP to the optimal TRP based on the autonomous switch not being configured at the UE.

In an example embodiment, the UE includes: a memory, and at least one processor coupled to the memory. The at least one processor is configured to: receive a plurality of TRP signals from a plurality of TRPs in the communication system. The at least one processor is configured to determine a set of TRPs from the plurality of TRPs based on a plurality of network parameters. The at least one processor is configured to cluster the set of TRPs into at least one cluster based on at least one characteristic related to the plurality of TRP signals. The at least one processor is configured to select a cluster from the at least one cluster. The at least one processor is configured to determine whether the selected cluster comprises a TRP better than a current TRP used by the UE. The at least one processor is configured to switch to the better TRP from the current TRP based on determining that the selected cluster comprises the TRP better than the current TRP. The at least one processor is configured to transmit a TRP switch message to at least one network apparatus.

In an example embodiment, a non-transitory computer-readable storage medium storing instructions which, when, executed by at least one processor of a user equipment (UE) in a communication system including multiple transmission-reception points (TRPs), cause the UE to perform operations is provided. The operations include receiving a plurality of TRP signals from a plurality of TRPs in the communication system. The operations include determining a set of TRPs from the plurality of TRPs based on a plurality of network parameters. The operations include clustering the set of TRPs into at least one cluster based on at least one characteristic related to the plurality of TRP signals. The operations include selecting a cluster for path switching from the at least one cluster. The operations include determining whether the selected cluster comprises a TRP better than a current TRP used by the UE. The operations include switching to the better TRP from the current TRP based on determining that the selected cluster comprises the TRP better than the current TRP. The operations include transmitting a TRP switch message to at least one network apparatus.

These and other aspects of the various example embodiments herein will be better appreciated and understood when considered in conjunction with the following description and the accompanying drawings. It should be understood, however, that the following descriptions, while indicating various example embodiments and numerous specific details thereof, are given by way of illustration and not of limitation. Many changes and modifications may be made within the scope of the disclosure herein without departing from the spirit thereof, and the disclosure includes all such modifications.

### BRIEF DESCRIPTION OF THE DRAWINGS

Various example embodiments of the disclosure are illustrated in the accompanying drawings, throughout which like reference letters indicate corresponding parts in the various figures. The above and other aspects, features and advantages of certain embodiments of the present disclosure will be more apparent from the following detailed description, taken in conjunction with the accompanying drawings, in which:

FIG. 1A and FIG. 1B are diagrams illustrating example scenarios of an area or cell including multi TRP of the radio network connected to the controller or C-RAN or control unit, according to various embodiments;

FIG. 1C is a diagram illustrating a scenario in which a user device can be served by multiple beam/TRP IDs in DL and/or uplink in a multi-TRP system, according to various embodiments;

FIG. 2 is a diagram illustrating a scenario of measurement model for 5G system, according to the prior art;

FIG. 3 is a block diagram illustrating an example configuration of the UE for multi Transmission-Reception Point (TRP) system, according to various embodiments;

FIG. 4 is a diagram illustrating a scenario of L1 measurement model for multi-TRP system, according to various embodiments;

FIG. 5 is a diagram illustrating a scenario of handling transmission-reception point (TRP) in a multi TRP telecommunication system, according to various embodiments;

FIG. 6 is a diagram illustrating a scenario of Legacy L3 based measurement/Measurement mode for multi-TRP system, according to various embodiments;

FIG. 7 is a flowchart illustrating an example method for measurement of the multi-TRP system, according to various embodiments;

FIG. 8 is a diagram illustrating a scenario of clustering TRPs, according to various embodiments;

FIG. 9 is a flowchart illustrating an example method for clustering the TRPs to the small subset of TRP signals (E) by the path learning of the UE, according to various embodiments;

FIG. 10 is a flowchart illustrating an example method for clustering the TRPs to the small subset of TRP signals (E) by the direction/orientation of the UE, according to various embodiments;

FIG. 11 is a flowchart illustrating an example method for clustering the TRPs to the small subset of TRP signals (E) by the radio parameters of the UE, according to various embodiments;

FIG. 12 is a flowchart illustrating an example method for adding and eliminating the TRPs from the small subset of TRP signals (E), according to various embodiments;

FIG. 13 is a flowchart illustrating an example method for eliminating a TRP signal from the small subset of TRP signals (E), according to various embodiments;

FIG. 14 is a flowchart illustrating an example of measurement procedures for multi-TRP systems, according to various embodiments;

FIG. 15 is a flowchart illustrating a scenario for L1 based measurements, according to various embodiments; and

FIG. 16 is a flowchart illustrating a scenario for L3 based measurements, according to various embodiments.

### DETAILED DESCRIPTION

The various example embodiments herein and the various features and advantageous details thereof are explained in greater detail with reference to the non-limiting embodiments that are illustrated in the accompanying drawings and detailed in the following description. Descriptions of well-known components and processing techniques may be omitted so as to not unnecessarily obscure the disclosure with unnecessary detail. Also, the various example embodiments described herein are not necessarily mutually exclusive, as various embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the disclosure.

Various example embodiments may be described and illustrated in terms of blocks which carry out a described function or functions. These blocks, which may be referred to herein as managers, units, modules, hardware components or the like, are physically implemented by an analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Below are example reference signals for handling transmission-reception point (TRP) in a multi TRP telecommunication system—
TSS: TRP synchronization symbol
TSS may be used for downlink synchronization and to estimate cell power.
TSS may include a broadcast signal which is present in every radio frame with a periodicity of x milliseconds.
TRP-RS: TRP reference signal
This may be used for the channel state estimation like in 5G.
The signal may be periodic, aperiodic or semi-persistent.
The signal may be used for RSRP measurement during mobility and beam change procedure.
TRP-RS is configured by the network via RRC Reconfiguration messages.
T-SRS: TRP Sounding reference signal
Similar to 5G, the SRS and may be used for UL channel estimation
The network may give out UE specific configuration for the transmission of SRS.
T-SRS is configured by the network via RRC Reconfiguration messages.
Report free mode.
From the chosen cluster, UE may perform T2 event based T-SRS reporting for measurement free modes

The following events may be included in the system to aid with TRP selection:
Event T1 may be used for cases where UE is in Measurement reporting free mode (mode2). UE can simply measure T1 and switch to a suitable TRP.
If (SNR_neighbour+Hys>SNR_Current), Switch to neighbour TRP;
SNR_neighbour may include the signal-to-noise ratio of the strongest neighbour found.
Hys may include the hysteresis parameter for this event.
SNR_Current may include the signal-to-noise ratio of the current serving cell.
Event T2 may be used for cases where UE is in Measurement free mode. As soon as current TRP signal quality drops below a threshold, UE may begin transmitting T-SRS to all the surrounding TRPs in the cluster.

### If (SNR_Current+Hys<Threshold_x)

### Transmit T_SRS;

Hys may include the hysteresis parameter for this event.
SNR_Current may include the signal-to-noise ratio of the current serving cell.
Threshold_x may include the threshold parameter for this event.

Accordingly the disclosure provides a system and method for handling transmission-reception point (TRP) in a multi TRP telecommunication system. The disclosed method provides a scenario of area or cell including multi Transmission/Reception Point (TRP) of the radio network connected to the controller or Central-Random Access Network (C-RAN) or control unit. Further, the disclosed method provides a configuration in which a user device can be served by multiple beam/TRP IDs in Downlink (DL) and/or uplink in a multi-TRP system.

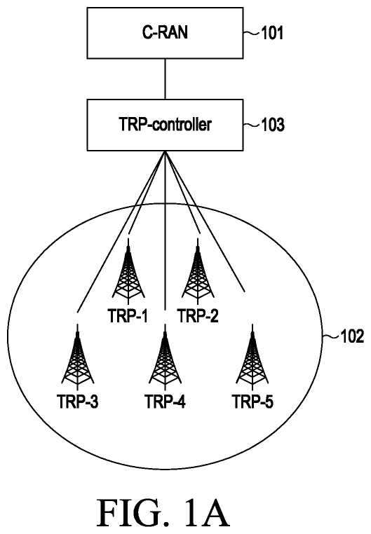

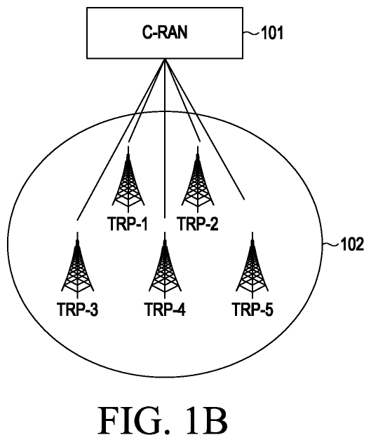

Referring now to the drawings and more particularly to FIGS. 1A, 1B and 1C, where similar reference characters denote corresponding features throughout the figures, there are shown various example embodiments.

FIG. 1A and FIG. 1B are diagrams illustrating a scenario of area or cell including multi TRP of the radio network connected to the controller or C-RAN or control unit, according to various embodiments.

Referring to FIG. 1A and FIG. 1B considering the disclosed method, the possible deployment for cell free architecture is described. FIG. 1A and FIG. 1B includes a Centralised-Random Access Network (C-RAN) (101). The C-RAN (101) may include a Centralized Unit (CU) or functionality of CU and Distributed Unit (DU) or new functionality, which can have radio access network functionality. The C-RAN (101) has defined area or region called as the cell or C-RAN region. A cell or C-RAN (101) may include multiple TRPs (102) on a same or different carrier. A user can be served through a single TRP or multiple TRPs. FIG. 1A includes a TRP controller (TRP-C) (103). The TRP-C (103) may include a new network node that communicates with multiple TRPs (102) and the C-RAN (101) entity.

The TRP-C (103) may be a new entity, which may control the multiple TRPs (102) within the cell or region defined by the C-RAN (101). The TRP-C (103) may be the new node at network or it may be part of existing network nodes like CU, DU, and the like. The THz or high frequency mmW link or mid band or sub 6 GHz may be sensitive and easily cause issues like blockage, deafness, handover and impact the user experience. The main functionality of the TRP-C (103) may include, beam management, switching of master node/decision about master node, handover intra TRP/and inter TRP, formation of cluster (list of TRPs who should serve the user) for each of the UE, addition and deletion of nodes in the cluster and the like.

FIG. 1B is a diagram illustrating a possible deployment for cell free architecture where TRP-C (103) is part of C-RAN (101) only. In the case multiple TRPs (102) are directly connected with the C-RAN (101) through wired or wireless interface and are being handled by the TRP-C (103) part of the CU, the DU or the C-RAN entity. The central unit could act as a mobility anchor and a centralized control node for multiple TRPs.

FIG. 1C is a diagram illustrating a scenario of where in a user device can be served by multiple beam/TRP IDs in DL and/or uplink in a multi-TRP system, according to various embodiments.

Referring to FIG. 1C considering the disclosed method, the measurement mode may be provided for cellular based systems in the current 3GPP specifications for various generations of communication technology, but does be included for a cell free or Multi-TRP system. FIG. 1C includes a UE (104), the TRP-C (103), and the C-RAN (101). The UE (104) is connected to multiple TRPs (103), so there is a need to define the measurement model for Multi TRP system.

The UE (104) is being served with multi TRP system where the TRPs (102) are being used to send uplink and downlink data. The TRPs (102) may either configured by the network or have been selected by the UE (104). The TRP-C (103) may create set of TRP set or selection of TRP which can serve the user. The current measurement model has been defined for cell which has multiple beams. In the cell free or multi TRP per cell or 6G based topology there may be no cell concept and the UE (104) may serve with the multiple TRPs (102). There is need to provide a new measurement model to cater to 6G topology design.

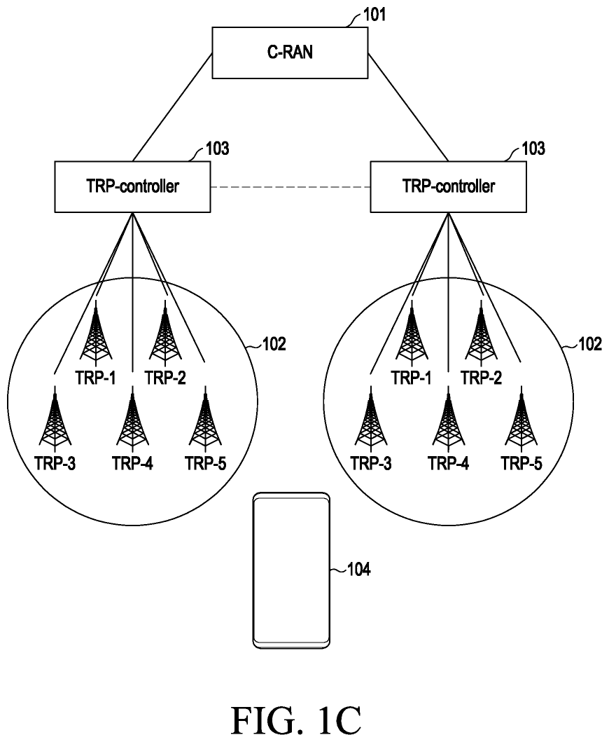

FIG. 2 is a diagram illustrating a scenario of measurement model for 5G system, according to the prior art.

Referring to FIG. 2 considering the conventional methods and systems, as per TS 38.300, in RRC_CONNECTED, the UE measures multiple beams (at least one) of a cell and the measurements results (power values) are averaged to derive the cell quality. In doing so, the UE is configured to consider a subset of the detected beams. Filtering takes place at two different levels: at the physical layer to derive beam quality and then at RRC level to derive cell quality from multiple beams. Cell quality from beam measurements is derived in the same way for the serving cell(s) and for the non-serving cell(s). Measurement reports may contain the measurement results of the X best beams if the UE is configured to do so by the network apparatus.

FIG. 2 includes, Layer 1 filters (201), Beam consolidation and selection block (202), Layer 3 filters (203), Evaluation (204), L3 Beam filters (205), and Beam Selection (206). The corresponding high-level measurement model is described below:
a. Measurements (beam specific samples) internal to the physical layer.
   Layer 1 filters (201): internal layer 1 filtering of the inputs measured at point A. exact filtering is implementation dependent. How the measurements are actually executed in the physical layer by an implementation (inputs A and Layer 1 filtering) in not constrained by the standard.
   A1: measurements (e.g., beam specific measurements) reported by layer 1 to layer 3 after layer 1 filtering (201).
   Beam Consolidation/Selection (202): beam specific measurements are consolidated to derive cell quality. The behaviour of the Beam consolidation/selection is standardised and the configuration of this module is provided by the RRC signalling. Reporting period at B equals one measurement period at A1.
b. A measurement (e.g., cell quality) derived from beam-specific measurements reported to layer 3 after beam consolidation/selection.
   Layer 3 filters (203) for cell quality: filtering performed on the measurements provided at point B. The behaviour of the Layer 3 filters (203) is standardised and the configuration of the layer 3 filters (203) is provided by the RRC signalling. Filtering reporting period at C equals one measurement period at B.
c. A measurement after processing in the layer 3 filters (203). The reporting rate is identical to the reporting rate at point B. This measurement is used as input for one or more evaluation (204) of reporting criteria. —Evaluation (204) of reporting criteria: checks whether actual measurement reporting is necessary at point D.
   The evaluation (204) may be based on more than one flow of measurements at reference point C e.g. to compare between different measurements. This is illustrated by input C and C1.
   The UE (104) may evaluate the reporting criteria at least every time a new measurement result is reported at point C, C1.
   The reporting criteria are standardised and the configuration is provided by the RRC signalling (UE measurements).
d. Measurement report information (message) sent on the radio interface. —L3 Beam filters (205): filtering performed on the measurements (e.g., beam specific measurements) provided at point A1.
   The behaviour of the L3 beam filters (205) is standardised and the configuration of the L3 beam filters (205) is provided by the RRC signalling. Filtering reporting period at E equals one measurement period at A1.
e. A measurement (e.g., beam-specific measurement) after processing in the L3 beam filters (205). The reporting rate is identical to the reporting rate at point A1. This measurement is used as input for selecting the X measurements to be reported).
   Beam Selection (206) for beam reporting: selects the X measurements from the measurements provided at point E. The behaviour of the beam selection (206) is standardised and the configuration of this module is provided by the RRC signalling.
f. Beam measurement information included in measurement report (sent) on the radio interface.

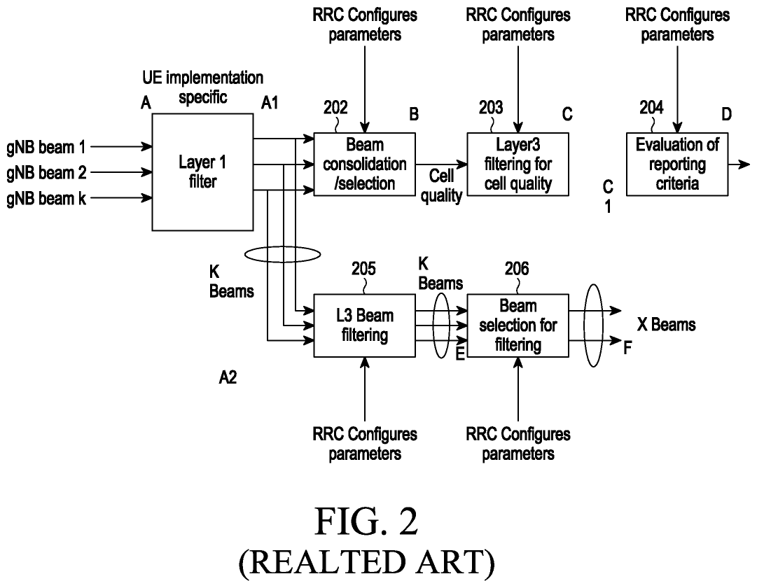

Referring now to the drawings and more particularly to FIG. 3, where similar reference characters denote corresponding features consistently throughout the figure, these are shown example embodiments.

FIG. 3 is a block diagram illustrating an example configuration of the UE (104) for multi Transmission-Reception Point (TRP) system, according to various embodiments.

In an embodiment, the UE (104) includes a memory (301) and a processor (e.g., including processing circuitry) (302) and a TRP cluster controller (e.g., including processing/control circuitry) (303).

The memory (301) may be configured to store measurement modes for multi Transmission-Reception Point (TRP) system. The memory (301) may store temporary and/or permanent information for operation of the processor (302) and/or the TRP cluster controller (303). The memory may comprise a non-transitory computer-readable storage medium storing instructions. When the instructions are executed by the processor (302) and/or the TRP cluster controller (303), the instructions may cause the UE (104) to perform operations described in the present disclosure.

In an embodiment, the TRP cluster controller (303) is communicatively coupled to the memory (301) and the processor (302) an may be configured to receive the TRP from the network apparatus in the Multi TRP telecommunication system. The TRP cluster controller (303) may be configured to determine a set of optimal (e.g., better, best or preferred) TRPs from the multiple TRPs based on the network parameters. The network parameters/cell parameters includes an uplink signal quality and a downlink signal quality. The TRP cluster controller (303) may be configured to cluster the set of optimal TRPs into a cluster of multiple clusters based on the plurality of TRP signal characteristics. The plurality of TRP signal characteristics includes a location of the UE, a current time, and a current mobile condition of the UE, a UL and DL performance on each TRP, and an interference level associated with each TRP. The TRP cluster controller (303) may be configured to select one cluster from the multiple TRP clusters for path switching. The TRP cluster controller (303) may be configured to determine whether the selected cluster includes an optimal TRP better than a current TRP used by the UE (104); The TRP cluster controller (303) may be configured to switch to the optimal TRP from the current TRP when the selected cluster includes the TRP better than the current TRP. The TRP cluster controller (303) may be configured transmit a TRP switch message to the network apparatus.

The processor (302) may control operations of other elements of the UE (104). The processor (302) may control overall operations of the UE (104). The processor (302) and the TRP cluster controller (303) may be integrally referred to as at least one processor.

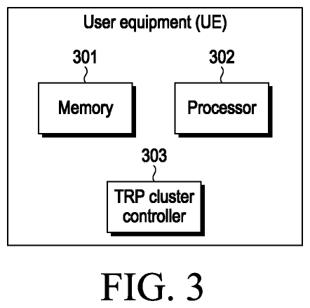

FIG. 4 is a diagram illustrating a scenario of L1 measurement model for multi-TRP system, according to various embodiments.

Referring to FIG. 4 considering the disclosed method, the corresponding (L1) high-level measurement model for the multi-TRP system is described below:
At 401, A is the live-air input TRP signals as seen by the UE (104);
At 402, A1 is the output after L1 layer has filtered the best TRPs based on TRP-SS measurement;
At 403, A2 is the output after L1 layer has filtered the best TRPs based on TRP-RS measurement;
At 404, clustering by which the UE (104) may be configured to choose a small subset of TRPs from what is available at A2, after L1 filter;
At 405, the small subset of TRPs (E) refers to a cluster chosen by the UE (104). The cluster (E) may either be configured by the network apparatus in RRC configuration or chosen by the UE (104);
At 406, from the chosen cluster (E), the UE (104) may perform TRP selection and switching without the network apparatus involvement; the output (F) is the TRP that the UE (104) has chosen autonomously from the cluster input (E); and
At 407, the TRP is chosen by the UE (104), the same is informed to the network apparatus.

The UE (104) may be configured to cluster the TRPs and then switch between TRPs within the cluster based on L1 measurements. L1 Measurement mode which does not involve a report to the network apparatus and may be said to be a ‘Measurement report free’ mode. Or Based on the measurement mode that the UE (104) is operating in, the UE (104) may either perform TRP selection in the legacy way (L3 based measurement) by measuring, reporting and waiting for the decision of the network apparatus to switch.

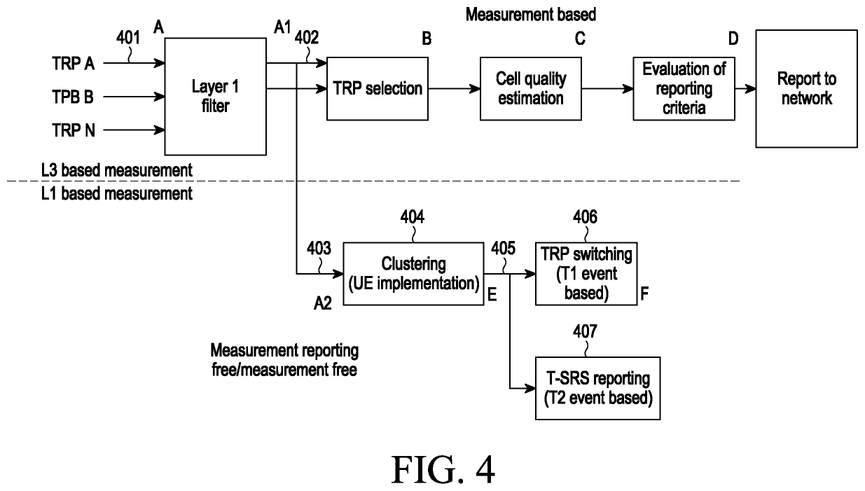

FIG. 5 is a diagram illustrating a scenario of handling transmission-reception point (TRP) in a multi TRP telecommunication system, according to various embodiments.

Referring to FIG. 5 considering the disclosed system, the system for handling transmission-reception point (TRP) in a multi TRP telecommunication system is described below:

FIG. 5 includes Layer 1 filter (501), a clustering unit (502), and TRP switching unit (503), each of which may include various circuitry and/or executable program instructions.

In an embodiment, the UE (104) may be configured to identify multiple TRP signals (A) of a network apparatus in the wireless network. A1 is the output after Layer 1 filter (501) filters the best TRPs based on TRP-SS measurement. The Layer 1 filter (501) may be configured to filter the best TRPs based on TRP-RS based on a reference signal transmitted from the network apparatus to select a set of TRPs (A2). The clustering unit (502) may be configured to cluster the set of TRP signals (A2) to obtain a small subset of TRPs (E) based on the most used TRPs (A2) at a given time and location. The small subset of TRPs (E) may refer to a cluster and may also be configured by the network apparatus in a Radio Resource Control (RRC) configuration. The cluster is one in which all the TRPs are Uplink synchronized or have similar TA value. This makes it easier for the UE (104) to switch to a new TRP by just measuring the downlink signal quality using the reference signal. The TRP switching unit (503) may be configured to measure a downlink signal quality for the small subset of TRPs (E). The TRP switching unit (503) may be configured to select a TRP (F) based on the downlink signal quality measured for the small subset of TRPs (E). The TRP switching unit (503) may be configured to switch to the TRP signal (F) in the small subset of TRPs (E) based on the downlink signal quality. The TRP switching unit (503) may be configured to send the switching information to the network apparatus.

In an embodiment, the clustering unit (502) may be configured to cluster the small subset of TRPs (E) from the set of TRPs (A2) using path learning, direction, and orientation, and a set of radio parameters of the UE (104). The clustering unit (502) may be configured to cluster the small subset of TRPs (E) from the set of TRPs (A2) using the path learning by the UE (104). The clustering unit (502) may be configured to identify the set of TRPs (A2) used at the predetermined location and time. The clustering unit (502) may be configured to store the set of TRPs (A2) used at the predetermined location and time in a database to create the small subset of TRP signals (E).

In an embodiment, the clustering unit (502) may be configured to cluster the small subset of TRPs (E) from the set of TRPs (A2) using direction, and orientation of the UE (104). The clustering unit (502) may be configured to monitor the direction and the orientation in which the UE (104) moves at the predetermined location and time. The clustering unit (502) may be configured to identify the set of TRPs (A2) used at the predetermined location and time in which the UE (104) moves. The clustering unit (502) may be configured to store the first set of TRP signals (A2) used in the at least one of the direction; and the orientation in the database to create the small subset of TRP signals (E). For each TRP ID, the database may contain path learning information, direction; and the orientation, if the TRP is used frequently and information on the quality of the signal.

In an embodiment, the clustering unit (502) may be configured to cluster the small subset of TRP signals (E) from the set of TRP signals (A2) using the set of radio parameters of the UE (104). The clustering unit (502) may be configured to monitor the set of TRP signals (A2) used at the predetermined time and location. The clustering unit (502) may be configured to determine a signal strength with the set of radio parameters of the set of TRP signals (A2). The clustering unit (306) may be configured to store the first set of TRP signals (A2) with the set of radio parameters in the database to create the small subset of TRP signals (E). The set of radio parameters may include, but not limited to, Reference Signals Received Power (RSRP), Timing Advance (TA) values, range of TX power, UL pathloss, and the like.

In an embodiment, the clustering unit (502) may be configured to determine a new TRP is frequently used at the predetermined time and location from the set of TRPs (A2). The clustering unit (502) may be configured to determine the new TRPs is being used in the direction; and the orientation by the UE (104) at the predetermined location and time. The clustering unit (502) may be configured to determine the new TRP signal is having a signal strength with the set of radio parameters. The clustering unit (502) may be configured to verify an uplink synchronization of the new TRP signal with the selected TRPs (F). The clustering unit (306) may be configured to add the new TRP signal to the small subset of TRPs (E) when the verification of the uplink synchronization with the TRP (F) is successful. The clustering unit (502) may be configured to eliminate the new TRP signal without adding to the small subset of TRP signals (E) when the verification of the uplink synchronization with the selected TRPs (F) is not successful. The small subset of TRPs (E) refers to a cluster and is configured by the network apparatus in a Radio Resource Control (RRC), and learning by the UE (104) using at least one machine learning model.

In an embodiment, the clustering unit (502) may be configured to determine the TRP (F) from the small subset of TRP signals (E) lost the uplink synchronization. The clustering unit (502) may be configured to determine the TRP (F) is not a part of the predetermined time and location from the small subset of TRP signals (E). The clustering unit (502) may be configured to determine the TRP (F) is not a part of the at least one of the direction; and the orientation from the small subset of TRP signals (E). The clustering unit (502) may be configured to determine the set of radio parameters of the TRP signal (F) is degraded from the small subset of TRP signals (E). The clustering unit (502) may be configured to determine the performance metrics of the TRP signal (F) is degraded from the small subset of TRP signals (E). The clustering unit (502) may be configured to determine the TRP signal (F) is prone to interference from the small subset of TRP signals (E). The clustering unit (306) may be configured to eliminate the TRP signal (F) from the small subset of TRP signals (E).

In an embodiment, the UE (104) may occasionally fine tune the cluster based on following:

If the cluster is detected that the TRP is not the same UL sync as the others; if the cluster is detected that a TRP is no longer falls on the learnt path of the UE (104); if the cluster is detected that a TRP is no longer useful to form a direction based set; if the cluster is detected that a TRP's radio parameters are different (or not within the allowed variation) from that of the rest in the cluster. For example: RSRP change, TA value changed, TX power required has changed or UL Pathloss changed and the like; If the cluster is detected that UL and DL performance on that TRP is poor; If the cluster is detected that the TRP is prone to interference. For the purpose of detecting if the TRP's performance is still up to the mark, the UE (104) may evaluate the time to time radio parameters. Effectiveness of the path learning of the UE (104) and direction set may also be fine-tuned at regular intervals.

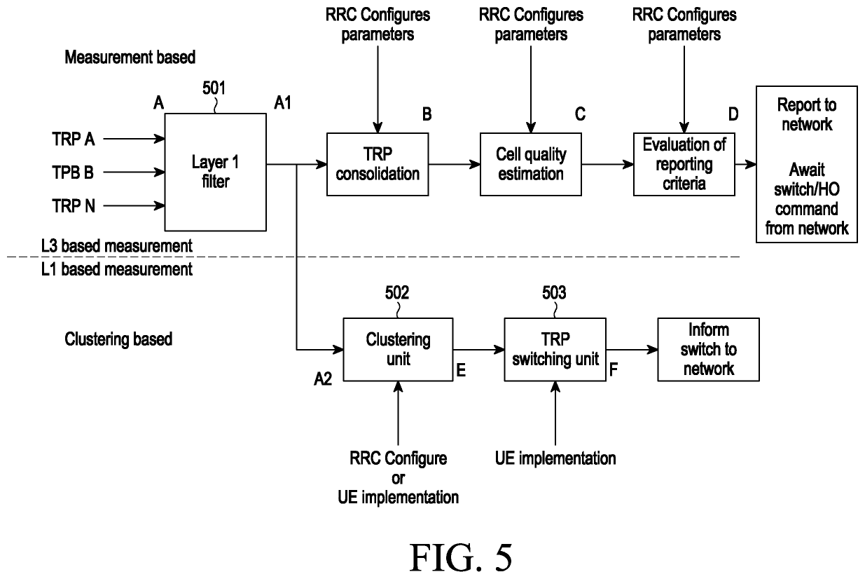

FIG. 6 is a diagram illustrating a scenario of Legacy L3 based measurement/Measurement mode for multi-TRP system, according to various embodiments.

Referring to FIG. 6 considering the disclosed method, the corresponding (L3) measurement model is described below:

At 601, A the live-air input TRP signals as seen by the UE (104). A1 is the output after L1 layer has filtered the best TRPs based on TRP-SS measurement.

At 602, TRP consolidation by which the UE (104) may arrive at a smaller set of suitable TRP after eliminating the poor signal quality TRPS, B is a set of TRP provided to L3 for cell quality estimation.

At 603, Cell quality is estimated based on the input B. the network apparatus configures the UE (104) with necessary configuration for the Cell quality estimation.

At 604, from the input at C, the reporting criteria may be evaluated as configured by the network apparatus. D is the TRP for which the measurement report is sent to the network apparatus.

At 605, once the measurement report is sent to the network apparatus, the UE (104) waits for the network apparatus to configure the new TRP based on the measurement report received.

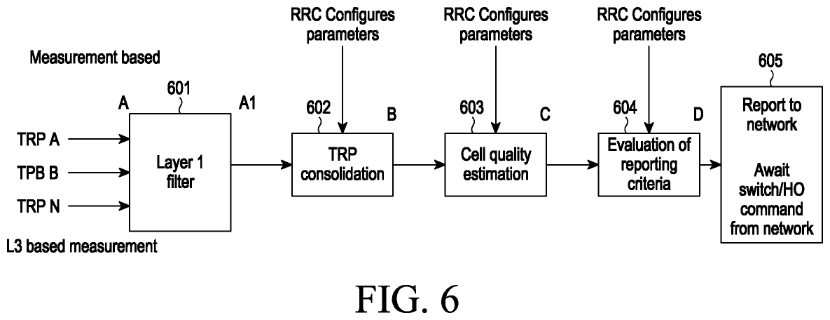

FIG. 7 is a flowchart illustrating an example method for measurement of the multi-TRP system, according to various embodiments.

At 701, the method includes configuring L1 and L3 measurement configurations by the network apparatus. The measurement configurations provide key information to the UE (104) on what and when to measure reference signals and their timing.

At 702, the method includes determining whether the UE (104) is operating in ‘Measurement reporting free’ mode.

If the answer at 702, is Yes, then the method continues at 703, the UE (104) selects a cluster of the TRPs within which the UE (104) can move freely without measurement reporting. The cluster either be configured by the network apparatus via explicit signalling or the UE (104) may also select the cluster by its own intelligence (for example, using machine learning model).

At 704, once a cluster is selected by the UE (104), the UE (104) continually monitor TRP-RS (reference signal) for all the TRPs that are a part of this cluster.

At 705, the method includes determining whether the UE (104) identified a better TRP than the currently selected TRP.

If the answer at 705, is Yes, the method continues at 706, the UE (104) may switch to the new TRP and inform the network apparatus of the switch via the report.

If the answer at 705, is No, the method redirects to 704.

If the answer at 702, is No, then the method continues at 707, the UE (104) performs the Legacy L3 based measurement/Measurement mode for multi-TRP (as shown in FIG. 6).

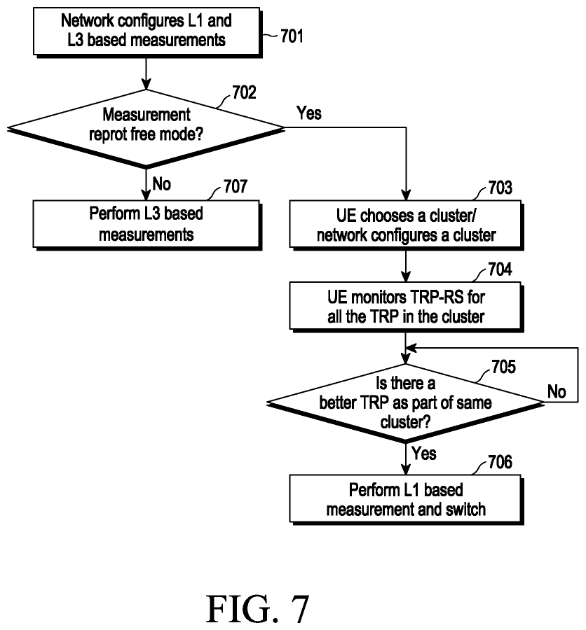

FIG. 8 is a diagram illustrating a scenario of clustering TRPs, according to various embodiments.

Referring to FIG. 8 considering the disclosed method, the clustering TRPs is described. FIG. 8 includes the UE (104) and the network apparatus.

The advantage of having a cluster is that the UE (104) may move freely amidst the cluster without having to perform measurements and reporting. As all the TRPs in the cluster may be UL synchronized, the RACH(UL sync) procedure need not be performed again. The measurement may be controlled by L1 procedures where the UE (104) measures downlink signal quality by means of the reference signal (TRP-RS). If the TRP-RS of a neighbouring TRP is better than the current TRP, the UE (104) may switch to the better TRP node. The cluster may either be configured by the network apparatus or the UE (104) can bunch the TRPs by its own intelligence and report it to the network apparatus.

Following are some example methods by which the UE (104) is configured to cluster a set of TRPs:

Path Learning: the UE (104) may be configured to learn the most used TRPs at a given time and location and the most used TRPs at a given time and location may be selected as a cluster.

Direction: select cluster such that at all directions of the UE (104), there is a TRP available.

Signal strength: the UE may select a cluster such that all the TRPs within the cluster may have a signal strength that is in the range of −xdbm to −ydbm.

The network apparatus may be configured to inform the UE (104) of the presence of the clusters and their respective TRP IDs via a system information broadcast. The network apparatus may also configure the UE (104) with the TRP-RS timing and other configuration such that the UE (104) measures the reference signal.

The UE may have intelligence to exclude TRPs from the cluster when the following occurs:
One of the TRPs is not in UL sync or it is found that there is high UL BLER or the TA values are different.
Exclude TRPs whose signal is frequently disrupted.
Exclude TRPs whose signal is noisy due to interference.

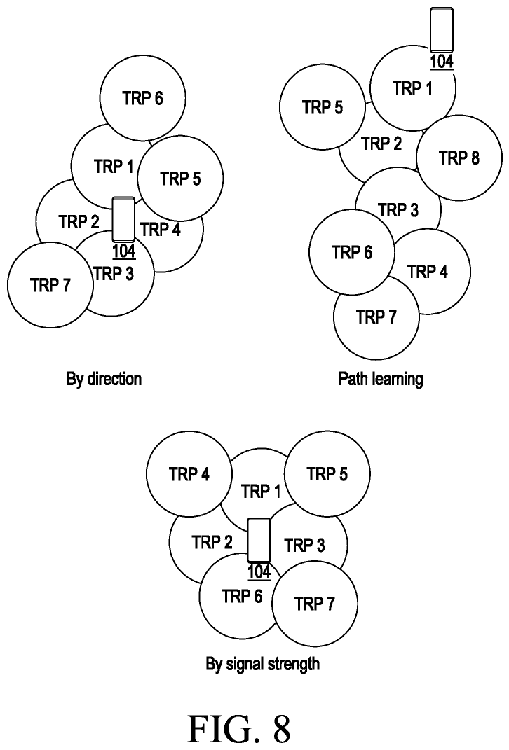

FIG. 9 is a flowchart illustrating an example method for clustering the TRPs to the small subset of TRP signals (E) by the path learning of the UE, according to various embodiments.

At 901, the method includes clustering by learning path.

At 902, the method includes given a particular location and time, learn the TRPs that the UE (104) uses the most, taking into account the static or mobile condition of the UE (104).

At 903, the method includes forming the cluster and reporting to the network apparatus.

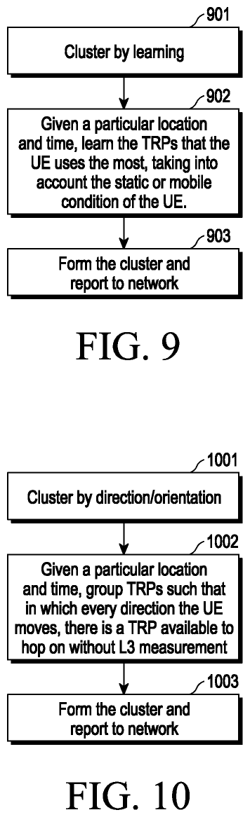

FIG. 10 is a flowchart illustrating an example method for clustering the TRPs to the small subset of TRP signals (E) by the direction/orientation of the UE, according to various embodiments.

At 1001, the method includes clustering by direction/orientation.

At 1002, the method includes given a particular location and time, group TRPs such that in which every direction the UE (104) moves, there is a TRP available to hop on without L3 measurement.

At 1003, the method includes forming the cluster and reporting to the network apparatus.

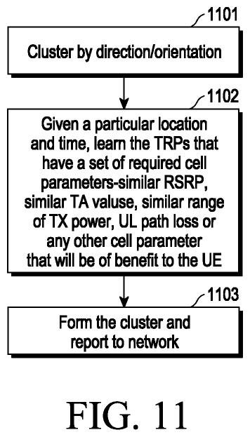

FIG. 11 is a flowchart illustrating an example method for clustering the TRPs to the small subset of TRP signals (E) by the radio parameters of the UE, according to various embodiments;

At 1101, the method includes clustering by radio parameters.

At 1102, the method includes given a particular location and time, learn the TRPs that have a set of required radio parameters similar RSRP, Similar TA values, similar range of TX power, UL pathloss or any other radio parameter that may be of benefit to the UE (101).

At 1103, the method includes forming the cluster and reporting to the network apparatus.

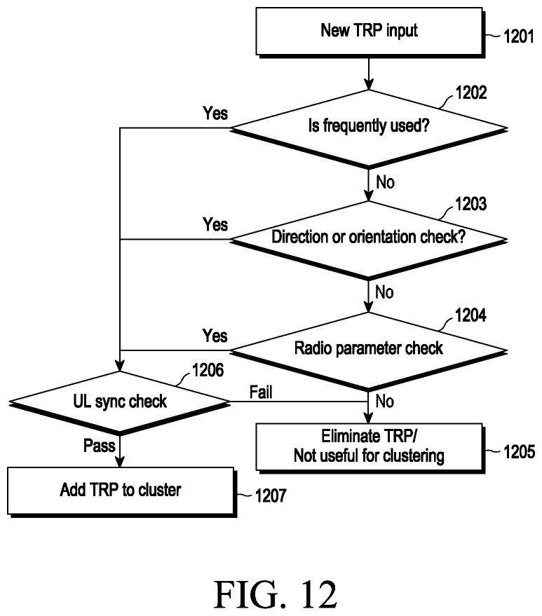

FIG. 12 is a flowchart illustrating an example method for adding and eliminating the TRPs from the small subset of TRP signals (E), according to various embodiments.

At 1201, the method includes determining, by the UE (104), a new TRP signal.

At 1202, the method includes determining, by the UE (104), whether a new TRP signal is frequently used at the predetermined time and location from the first set of TRP signals (A2);

If answer at 1202 is No, the method at 1203, includes determining, by the UE (104), the new TRP signal is used in the direction; and/or the orientation at the predetermined location and time.

If answer at 1203 is No, the method at 1204, includes determining, by the UE (104), the at least one new TRP signal is having a signal strength with the set of radio parameters.

If answer at 1204 is No, the method at 1205, includes eliminating, by the UE (104), the at least one new TRP signal without adding to the small subset of TRP signals (E).

If the answer at any of step 1202, 1203, 1204 is Yes, the method at 1206 includes verifying, by the UE (104), an uplink synchronization of the new TRP signal with the first candidate TRP signal (F1).

If the answer at 1206 is Pass, the method continues at 1207, the method includes adding, by the UE (104), the at least one new TRP signal to the small subset of TRP signals (E) when the verification of the uplink synchronization is successful.

If the answer at 1205 is Fail, the method continues at 1205, the method includes eliminating, by the UE (104), the at least one new TRP signal without adding to the small subset of TRP signals (E) when the verification of the uplink synchronization with the first candidate TRP signal (F1) is not successful.

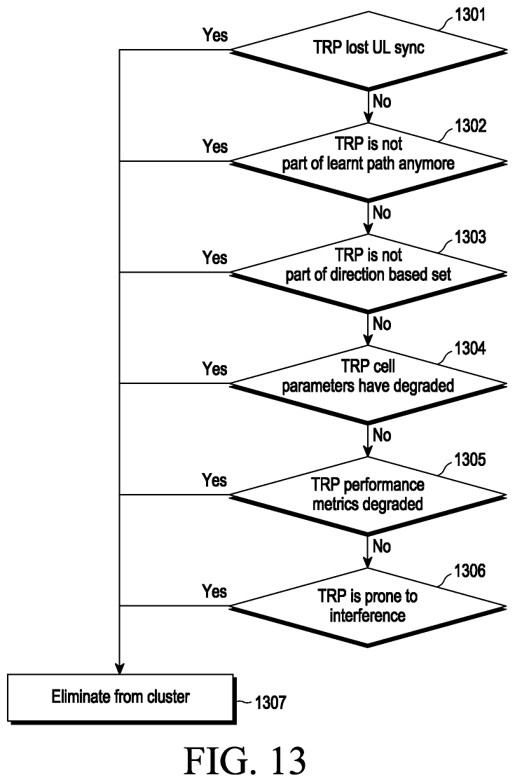

FIG. 13 is a flowchart illustrating an example method for eliminating a TRP signal from the small subset of TRP signals (E), according to various embodiments.

At 1301, the method includes determining, by the UE (104), whether the TRP signal from the small subset of TRP signals (E) lost the uplink synchronization.

If the answer at 1301 is No, the method continues at 1302, the method includes determining, by the UE (104), whether the TRP signal is not a part of the predetermined time and location from the small subset of TRP signals (E).

If the answer at 1302 is No, the method continues at 1303, the method includes determining, by the UE (104), whether the TRP signal is not a part of the direction; and the orientation from the small subset of TRP signals (E).

If the answer at 1303 is No, the method continues at 1304, the method includes determining, by the UE (104), whether the set of radio parameters of the TRP signal are degraded from the small subset of TRP signals (E).

If the answer at 1304 is No, the method continues at 1305, the method includes determining, by the UE (104) whether the performance metrics of the TRP signal are degraded from the small subset of TRP signals (E).

If the answer at 1305 is No, the method continues at 1306, the method includes determining, by the UE (104) whether the TRP signal is prone to interference from the small subset of TRP signals (E).

If the answer at any of step 1301, 1302, 1303, 1304, 1305, 1306 is Yes, the method continues at 1307, the method includes eliminating, by the UE (104) the TRP signal from the small subset of TRP signals (E).

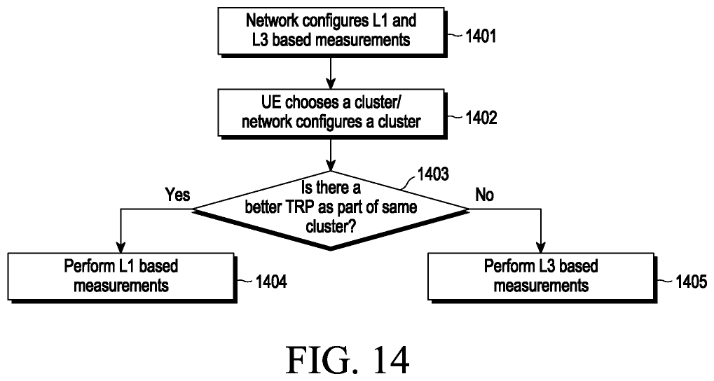

FIG. 14 is a flowchart illustrating an example of measurement procedures for multi-TRP systems, according to various embodiments.

Referring to FIG. 14 considering the disclosed method, the method includes the following operations:

At 1401, configuring L1 measurements and L3 measurements.

At 1402, the UE (102) selects a cluster/Network configures a cluster.

At 1403, determining whether there is a better TRP as part of same cluster.

At 1403, if the answer is Yes, the method continues at 1404, performing L1 based measurement. L1 measurements may happen within a cluster of TRPs that have the same UL and DL sync. L1 measurements may aid the UE (104) to switch quickly to a better TRP without the need for network intervention. L1 based switching may occur in two ways, the UE measuring a better TRP and switching to it or UE reporting measurements in an UL report and the network would change the TRP. For the purpose of L1 measurements, a new reference signal TRP-RS may be used. The network may provide the UE (104) with the necessary configuration for TRP-RS measurement. The network may also configure if the UE (104) may measure and switch to the best available TRP without network intervention.

At 1403, if the answer is No, the method continues at 1405, Performing L3 measurements. L3 measurements may be described for TRPs that are not necessary in sync and/or are part of a different cell/frequency.

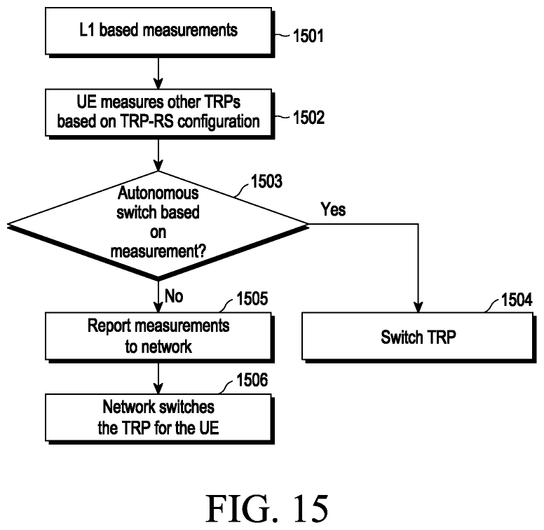

FIG. 15 is a flowchart illustrating an example method for L1 based measurements, according to various embodiments.

Referring to FIG. 15 considering the disclosed method, illustrates an example of L1 measurements.

At 1501, the method includes performing L1 based measurement.

At 1502, the method includes UE measuring other TRPs based on TRP-RS configuration.

At 1503, the method includes determining whether the Autonomous Switch is based on measurement.

If the answer at 1503 is Yes, the method continues at 1504, the method includes performing TRP switch.

If the answer at 1503 is No, the method continues at 1505, the method includes reporting measurements to the network apparatus.

At 1506, the method includes network switches the TRP for the UE.

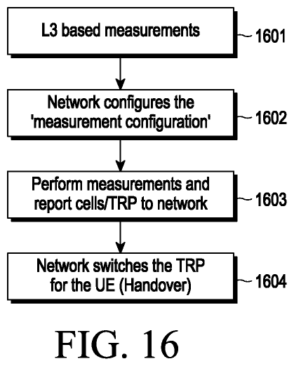

FIG. 16 is a flowchart illustrating an example method for L3 based measurements, according to various embodiments.

Referring to FIG. 16 considering the disclosed method, illustrates the scenario for L3 measurements.

At 1601, the method includes performing L3 measurements.

At 1602, the method includes network apparatus configures the measurement configuration.

At 1603, the method includes performing measurements and report cells/TRP to the network apparatus.

At 1604, the method includes the network switches the TRP for the UE.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for handling transmission-reception points (TRPs) by a user equipment (UE) in a communication system including multiple TRPs, comprising:
receiving a plurality of TRP signals from a plurality of TRPs in the communication system;
determining a set of TRPs from the plurality of TRPs based on a plurality of network parameters;
clustering the set of TRPs into at least one cluster based on at least one characteristic related to the plurality of TRP signals;
selecting a cluster for path switching from the at least one cluster;
determining whether the selected cluster comprises a TRP better than a current TRP used by the UE;
switching to the better TRP from the current TRP based on determining that the selected cluster comprises the TRP better than the current TRP; and
transmitting a TRP switch message to at least one network apparatus.

2. The method of claim 1, wherein clustering the set of TRPs into the at least one cluster comprises:
determining an uplink (UL) synchronization for each of the set of the TRPs based on the at least one characteristic related to the plurality of TRP signals; and
performing one of:
adding at least one TRP from the set of TRPs that shares a same UL synchronization to the at least one cluster, and sending a message informing about the at least one cluster to the at least one network apparatus, and
eliminating at least one TRP from the set of TRPs that does not share the same UL synchronization.

3. The method of claim 2, further comprising:
determining a group of TRPs from the set of TRPs for different directions of the UE based on the at least one characteristic related to the plurality of TRP signals, wherein the group of TRPs for different directions of the UE provides that in whichever direction the UE moves a TRP is available to hop on without L3 measurement; and
determining at least one candidate TRP from the set of TRPs by applying at least one machine learning model to a plurality of TRP signal characteristics, wherein the at least one candidate TRP is frequently used by the UE, and has a set of cell parameters; and
determining a TRP of the set of TRPs based on the group of TRPs for different directions of the UE, and the at least one candidate TRP.

4. The method of claim 3, wherein the set of cell parameters comprises at least one of a higher threshold and a lower threshold Reference Signals Received Power (RSRP), a same Timing Advance (TA) value, a same transmission (TX) power, or a same UL pathloss.

5. The method of claim 1, wherein the plurality of network parameters comprises an uplink and a downlink signal quality.

6. The method of claim 1, wherein the at least one characteristic related to the plurality of TRP signals comprises a location of the UE, a current time, a current mobile condition of the UE, a UL and downlink (DL) performance on each TRP signal, or an interference level associated with each TRP.

7. The method of claim 1, wherein switching to the better TRP from the current TRP comprises:
performing a first layer (L1) measurement based on the better TRP; and
determining whether an autonomous switch is configured at the UE; and
performing one of:
switching from the current TRP to the optimal TRP based on the L1 measurement based on the autonomous switch being configured at the UE, and transmitting the TRP switch message to the at least one network apparatus, and
reporting the L1 measurement to the at least one network apparatus to switch from the current TRP to the optimal TRP based on the autonomous switch not being configured at the UE.

8. The method of claim 1, wherein the at least one cluster is at least one of configured by the at least one network apparatus in a radio resource control (RRC) configuration, and learning by the UE using at least one machine learning model.

9. A UE for handling transmission-reception points (TRPs) in a communication system including multiple TRPs, the UE comprising:
a memory; and
at least one processor coupled to the memory, wherein the at least one processor is configured to:
receive a plurality of TRP signals from a plurality of TRPs in the communication system;
determine a set of TRPs from the plurality of TRPs based on a plurality of network parameters;
cluster the set of TRPs into at least one cluster based on at least one characteristic related to the plurality of TRP signals;
select a cluster from the at least one cluster;
determine whether the selected cluster comprises a TRP better than a current TRP used by the UE;
switch to the better TRP from the current TRP based on determining that the selected cluster comprises the TRP better than the current TRP; and
transmit a TRP switch message to at least one network apparatus.

10. The UE of claim 9, wherein for clustering the set of TRPs into the at least one cluster, the at least one processor is configured to:
determine an uplink (UL) synchronization for each of the set of the TRPs based on the at least one characteristic related to the plurality of TRP signals; and
perform one of:
adding at least one TRP from the set of TRPs that shares a same UL synchronization to the at least one cluster, and sending a message informing about the at least one cluster to the at least one network apparatus, and
eliminating at least one TRP from the set of TRPs that does not share the same UL synchronization.

11. The UE of claim 10, wherein the at least one processor is configured to:
determine a group of TRPs from the set of TRPs for different directions of the UE based on the at least one characteristic related to the plurality of TRP signals, wherein the group of TRPs for different directions of the UE provides that in whichever direction the UE moves a TRP is available to hop on without L3 measurement; and
determine at least one candidate TRP from the set of TRPs by applying at least one machine learning model to a plurality of TRP signal characteristics, wherein the at least one candidate TRP is frequently used by the UE, and has a set of cell parameters; and
determine a TRP of the set of TRPs based on the group of TRPs for different directions of the UE, and the at least one candidate TRP.

12. The UE of claim 11, wherein the set of cell parameters comprises at least one of a higher threshold and a lower threshold Reference Signals Received Power (RSRP), a same Timing Advance (TA) value, a same transmission (TX) power, or a same UL pathloss.

13. The UE of claim 9, wherein the plurality of network parameters comprises an uplink and a downlink signal quality.

14. The UE of claim 9, wherein the at least one characteristic related to the plurality of TRP signals comprises a location of the UE, a current time, a current mobile condition of the UE, a UL and downlink (DL) performance on each TRP signal, or an interference level associated with each TRP.

15. The UE of claim 9, wherein for switching to the better TRP from the current TRP, the at least one processor is configured to:
perform a first layer (L1) measurement based on the better TRP; and
determine whether an autonomous switch is configured at the UE; and
perform one of:
switching from the current TRP to the optimal TRP based on the L1 measurement based on the autonomous switch being configured at the UE, and transmitting the TRP switch message to the at least one network apparatus, and
reporting the L1 measurement to the at least one network apparatus to switch from the current TRP to the optimal TRP based on the autonomous switch not being configured at the UE.

16. The UE of claim 9, wherein the at least one cluster is at least one of configured by the at least one network apparatus in a radio resource control (RRC) configuration, and learning by the UE using at least one machine learning model.

17. A non-transitory computer-readable storage medium storing instructions which, when, executed by at least one processor of a user equipment (UE) in a communication system including multiple transmission-reception points (TRPs), cause the UE to perform operations, the operations comprising:
receiving a plurality of TRP signals from a plurality of TRPs in the communication system;
determining a set of TRPs from the plurality of TRPs based on a plurality of network parameters;
clustering the set of TRPs into at least one cluster based on at least one characteristic related to the plurality of TRP signals;
selecting a cluster for path switching from the at least one cluster;
determining whether the selected cluster comprises a TRP better than a current TRP used by the UE;
switching to the better TRP from the current TRP based on determining that the selected cluster comprises the TRP better than the current TRP; and
transmitting a TRP switch message to at least one network apparatus.

18. The non-transitory computer-readable storage medium of claim 17, wherein clustering the set of TRPs into the at least one cluster comprises:
determining an uplink (UL) synchronization for each of the set of the TRPs based on the at least one characteristic related to the plurality of TRP signals; and
performing one of:
adding at least one TRP from the set of TRPs that shares a same UL synchronization to the at least one cluster, and sending a message informing about the at least one cluster to the at least one network apparatus, and
eliminating at least one TRP from the set of TRPs that does not share the same UL synchronization.

19. The transitory computer-readable storage medium of claim 18, wherein the operations further comprises:
determining a group of TRPs from the set of TRPs for different directions of the UE based on the at least one characteristic related to the plurality of TRP signals, wherein the group of TRPs for different directions of the UE provides that in whichever direction the UE moves a TRP is available to hop on without L3 measurement; and
determining at least one candidate TRP from the set of TRPs by applying at least one machine learning model to a plurality of TRP signal characteristics, wherein the at least one candidate TRP is frequently used by the UE, and has a set of cell parameters; and
determining a TRP of the set of TRPs based on the group of TRPs for different directions of the UE, and the at least one candidate TRP.

20. The transitory computer-readable storage medium of claim 17, wherein switching to the better TRP from the current TRP comprises:
performing a first layer (L1) measurement based on the better TRP; and
determining whether an autonomous switch is configured at the UE; and
performing one of:
switching from the current TRP to the optimal TRP based on the L1 measurement based on the autonomous switch being configured at the UE, and transmitting the TRP switch message to the at least one network apparatus, and
reporting the L1 measurement to the at least one network apparatus to switch from the current TRP to the optimal TRP based on the autonomous switch not being configured at the UE.
